(19) United States
(12) Patent Application Publication
(10) Pub. No.: US 2024/0248745 A1
(43) Pub. Date: Jul. 25, 2024

(54) RESOURCE DETERMINATION DEVICE, METHOD, AND PROGRAM

(71) Applicant: Nippon Telegraph and Telephone Corporation, Tokyo (JP)

(72) Inventors: Chao WU, Musashino-shi, Tokyo (JP); Kenichi TAYAMA, Musashino-shi, Tokyo (JP); Shingo HORIUCHI, Musashino-shi, Tokyo (JP); Kenji MURASE, Musashino-shi, Tokyo (JP); Hiroaki KIKUSHIMA, Musashino-shi, Tokyo (JP)

(21) Appl. No.: 18/283,368

(22) PCT Filed: Mar. 25, 2021
(86) PCT No.: PCT/JP2021/012509

§ 371 Date: Apr. 12, 2024

(51) Int. Cl. G06F 9/455; G06F 9/50

(52) U.S. Cl. CPC G06F 9/45558; G06F 9/5077; G06F 2009/4557; G06F 2009/45583

(57) ABSTRACT

A resource determination device according to one embodiment includes a storage unit that stores a model that indicates relationship among resource arrangement of a virtual machine, a plurality of types of processing loads of the virtual machine, and processing performance of the virtual machine, a function derivation unit that derives a function using the resource arrangement as an argument and a processing load having relatively high relevance to the processing performance as a return value, and a determination unit that calculates the processing load in the resource arrangement that is designated on the basis of the function, calculates the processing performance in the designated resource arrangement by inputting the calculated processing load to the model, and determines that the designated resource arrangement is appropriate in a case where the calculated processing performance satisfies a requirement.

### TECHNICAL FIELD

Embodiments of the present invention relate to a resource determination device, a method, and a program.

### BACKGROUND ART

In a virtual desktop infrastructure (VDI) environment, calculating a resource amount appropriately allocated according to a performance requirement, for example, a count of virtual machines (VMs) that can be arranged in a host is necessary.

In order to automatically calculate the resource amount, a method for training a learning model in which relationship among the resource amount, work loads, and performance that is processing performance, that is, dependency relationship is expressed, and calculating, that is, back calculating, the resource amount to be allocated according to a predetermined performance requirement using the model can be applied (for example, see Non Patent Literature 1).

### CITATION LIST

### Non Patent Literature

Non Patent Literature 1: C. Wu, H. Shingo, K. Tayama, “A Resource Design Framework for Intent-based Cloud Management”, IEEE Cloudcom 2019, Sydney, December 2019, p 37-44.

### SUMMARY OF THE INVENTION

### Technical Problem

Although past log data can be used in training of a model, an operation of greatly varying the count of VMs is not performed in actual use of the VDI, and thus variation of a resource amount to be allocated is extremely small in the past log data.

Therefore, relationship between a resource amount and performance cannot be accurately expressed in the model, and calculating a resource amount to be allocated according to a performance requirement with high accuracy using the learning model is difficult.

The present invention has been made in view of the above circumstances, and an object thereof is to provide a resource determination device, a method, and a program capable of calculating a resource amount to be allocated with high accuracy.

### Solution to Problem

A resource determination device according to one aspect of the present invention includes a storage unit that stores a model that indicates relationship among resource arrangement of a virtual machine, a plurality of types of processing loads of the virtual machine, and processing performance of the virtual machine, an extraction unit that extracts a type of a processing load having relatively high relevance to the processing performance from the plurality of types of processing loads, a function derivation unit that derives a function using the resource arrangement as an argument and a processing load related to a type extracted by the extraction unit as a return value, and a determination unit that calculates the processing load in the resource arrangement that is designated on the basis of a function derived by the function derivation unit, calculates the processing performance in the designated resource arrangement by inputting the calculated processing load to the model, and determines that the designated resource arrangement is appropriate resource arrangement in a case where the calculated processing performance satisfies a requirement of corresponding processing performance.

A resource determination method according to the one aspect of the present invention performed by a resource determination device that uses a model that indicates relationship among resource arrangement of a virtual machine, a plurality of types of processing loads of the virtual machine, and processing performance of the virtual machine, the resource determination method including extracting a type of a processing load having relatively high relevance to the processing performance from the plurality of types of processing loads, deriving a function using the resource arrangement as an argument and a processing load related to the extracted type as a return value, and calculating the processing load in the resource arrangement that is designated on the basis of the derived function, calculating the processing performance in the designated resource arrangement by inputting the calculated processing load to the model, and determining that the designated resource arrangement is appropriate resource arrangement in a case where the calculated processing performance satisfies a requirement of corresponding processing performance.

### Advantageous Effects of the Invention

According to the present invention, a resource amount to be allocated can be calculated with high accuracy.

### BRIEF DESCRIPTION OF THE DRAWINGS

FIG. 1 is a block diagram illustrating an application example of a resource determination device according to one embodiment of the present invention.

FIG. 2 is a diagram illustrating an example of relationship between feature amounts for a model and performance.

FIG. 3 is a diagram illustrating an example of a VM count, a host central processing unit (CPU) usage rate, and host disk usage status at each time in past log data in a table format.

FIG. 4 is a diagram illustrating an example of a host CPU usage rate per unit VM and host disk usage status per unit VM at each time in a table format.

FIG. 5 is a diagram illustrating an example of input and output by an optimum VM count calculation unit of the resource determination device according to the one embodiment of the present invention.

FIG. 6 is a flowchart illustrating an example of processing operation by the optimum VM count calculation unit of the resource determination device according to the one embodiment of the present invention.

FIG. 7 is a diagram illustrating an example of a comparison result between predicted values and actual values of performance by the resource determination device according to the one embodiment of the present invention.

FIG. 8 is a block diagram illustrating an example of a hardware configuration of the resource determination device according to the one embodiment of the present invention.

### DESCRIPTION OF EMBODIMENTS

Hereinafter, one embodiment according to the present invention will be described with reference to the drawings.

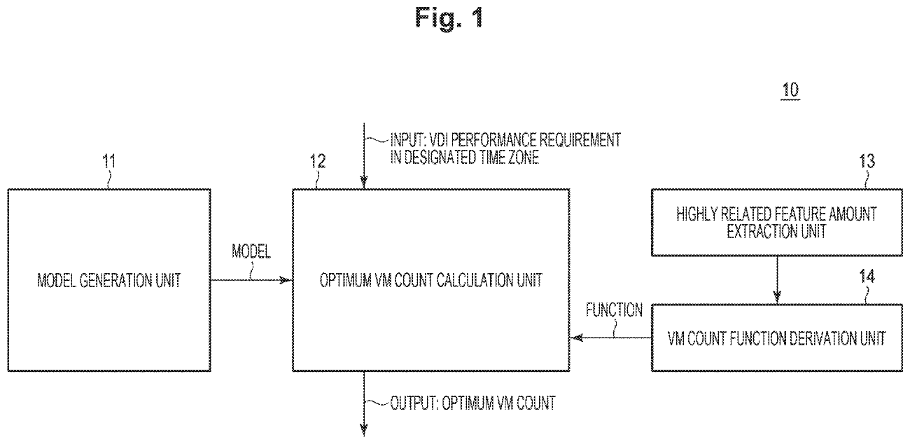

FIG. 1 is a block diagram illustrating an application example of a resource determination device according to the one embodiment of the present invention.

As illustrated in FIG. 1, a resource determination device 10 according to the one embodiment of the present invention includes a model generation unit 11, an optimum VM count calculation unit 12, a highly related feature amount extraction unit 13, and a VM count function derivation unit 14.

In the present embodiment, the resource determination device 10 extracts or selects types of feature amounts having relatively high relevance to performance (hereinafter, the feature amounts may be referred to as highly related feature amounts), for example, a host CPU usage rate from types of feature amounts of a resource (hereinafter, the feature amounts may be referred to as feature amounts), and derives relationship between these types of highly related feature amounts and a resource amount.

The resource determination device 10 can predict performance in a situation where a certain resource amount is allocated on a base of types of feature amounts having high relevance to the performance. Therefore, a resource amount satisfying a performance requirement can be calculated with high accuracy.

Specifically, the resource determination device 10 first analyzes relationship between the performance and feature amounts of other types other than the resource amount, and selects types of feature amounts having high relevance to the performance.

Next, the resource determination device 10 derives, for each of these types of the feature amounts, a function using at least the resource amount as an argument and a feature amount of a corresponding type as a return value.

In a situation where a certain resource amount is allocated, the resource determination device 10 predicts performance from the feature amount using a trained model used to calculate types of feature amounts having high relevance to performance. As a result, a resource amount satisfying the performance requirement can be derived.

By the above prediction being performed, a resource amount allocated according to a performance requirement of a VDI can be calculated with high accuracy even in a case where variation regarding the allocated resource amount is insufficient in log data.

Therefore, operation in calculation of the allocated resource amount by an operator of the VDI can be expected to be reduced, the efficiency of resource usage can be expected to be improved, and the quality of experience of a user of the VDI can be expected to be improved.

In the present embodiment, the following processing is performed in order to calculate a resource amount to be allocated in a VDI scenario.

In the present embodiment, a case will be described in which the present invention is applied to calculation of an “optimum VM count per host” (abbreviated as an optimum VM count) that is a representative resource amount to be allocated in a VDI environment, but the present invention can also be applied to calculation of other resource amounts in other VDI environments.

As a premise, the model generation unit 11 has collected past log data regarding the following feature variables and objective variables from the VDI environment.

The model generation unit 11 trains a model in which the following feature variables and objective variables are expressed using the above collected past log data. This trained model is stored in an internal memory of the resource determination device 10 or in a separate external storage device, for example.

The feature variables of the model include resource arrangement and work loads.

Specifically, examples of the above resource arrangement include a count of VMs arranged in the host and the like.

Furthermore, specific examples of the above work loads include a host CPU usage rate, a memory usage rate, disk usage status, network traffic, and the like.

The objective variables of the model include performance of the VDI in a case where resource arrangement, work loads, and the like indicated by the feature variables are allocated, specifically, host CPU ready time, host disk write delay, host disk read delay, and the like.

The optimum VM count calculation unit 12 calculates performance for a corresponding set VM count using a VM count function to be described below according to a settable VM count and using a model generated by the model generation unit 11, and stores VM counts that can satisfy all performance requirements as appropriate VM counts among set various VM counts. Furthermore, the optimum VM count calculation unit 12 sets the maximum VM count among the appropriate VM counts as an optimum VM count and outputs the optimum VM count.

In the present embodiment, the resource determination device 10 indirectly calculates the optimum VM count using dependency relationship between performance and feature amounts other than the VM counts and dependency relationship between the other feature amounts and the VM counts.

Next, an outline of functions of the highly related feature amount extraction unit 13 and the VM count function derivation unit 14 will be described.

The highly related feature amount extraction unit 13 of the resource determination device 10 selects types of highly related feature amounts having high relevance to performance that is an objective variable of the model.

For each of these selected types, the VM count function derivation unit 14 derives a function using a VM count and time, for example, time or date and time as arguments and a feature amount of a corresponding type as a return value. In the present embodiment, this function may be referred to as a VM count function.

When any of the VM counts that is settable by a user is set, the optimum VM count calculation unit 12 of the resource determination device 10 calculates values of highly related feature amounts at any time, for example, a host CPU usage rate and a host disk usage rate, on the basis of products of the VM count and functions using time as an argument and the highly related feature amounts per unit VM as return values.

The optimum VM count calculation unit 12 inputs these calculation results as feature variables of the model generated by the model generation unit 11, and predicts performance at any time, for example, host CPU ready time, as an objective variable of the model.

Then, the optimum VM count calculation unit 12 calculates an optimum VM count on the basis of a VM count when the predicted performance satisfies a performance requirement.

Next, details of the functions of the highly related feature amount extraction unit 13 and the VM count function derivation unit 14 will be described.

Specifically, the highly related feature amount extraction unit 13 acquires feature amounts other than VM counts, for example, variation including host CPU usage rates, memory usage rates, disk usage status, and the like, and dependency relationship between these feature amounts and performance from, for example, the internal memory of the resource determination device 10 or a separate storage device.

On the basis of this acquisition result, the highly related feature amount extraction unit 13 selects types of feature amounts having high dependency relationship with the performance among these feature amounts.

The dependency relationship between the feature amounts and the performance can be identified by various methods, and for example, there is a method for calculating existing Pearson product-moment correlation coefficients and determining the correlation between the feature amounts and the performance on the basis of the calculation result.

The VM count function derivation unit 14 derives functions using a VM count and time as arguments and types of highly related feature amounts selected by the highly related feature amount extraction unit 13 as return values.

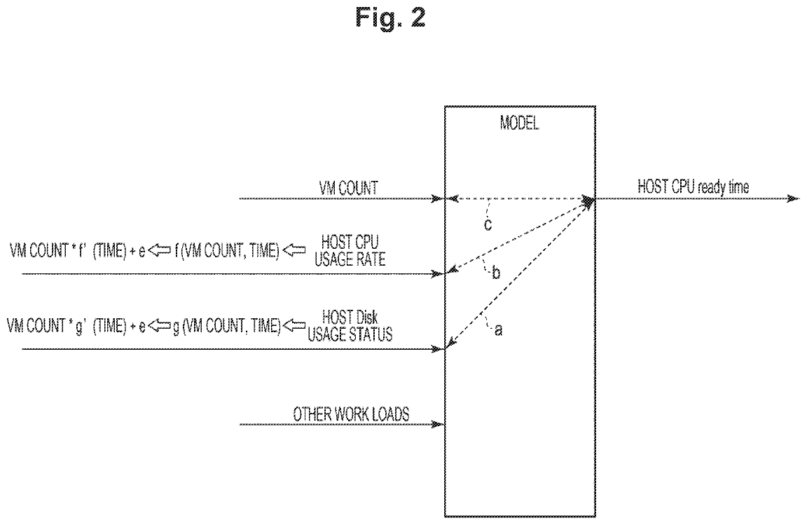

FIG. 2 is a diagram illustrating an example of relationship between feature amounts for a model and performance.

In the example illustrated in FIG. 2, a host CPU usage rate and host disk usage status are selected as the types of the highly related feature amounts for host CPU ready time that is the performance (see reference signs a and b in FIG. 2). The host disk usage status is also referred to as a host disk usage rate.

Functions using these types of feature amounts as return values are derived by being defined for the types as functions using a VM count and time as arguments. Note that, in the example illustrated in FIG. 2, the degree of relevance between the VM count and the host CPU ready time is unknown (see a reference sign c in FIG. 2).

In the example illustrated in FIG. 2, a function using the VM count and time as arguments and a host CPU usage rate as a return value is expressed as “f(VM count, time)”. Furthermore, a function using the VM count and time as arguments and host disk usage status as a return value is expressed as “g(VM count, time)”.

There are several patterns for defining a function using a highly related feature amount as a return value and deriving a corresponding feature amount. Since it can be assumed that a host resource usage rate is proportional to a VM count on the assumption that “each VM in the same host gives the same load.”, that is, VDI users are similar users, the above function f(VM count, time) can be converted as in following Formula (1). That is, a function using a VM count and time as arguments and a host CPU usage rate as a return value can be converted into a sum of a product of a function using time as an argument and a host CPU usage rate in a VM per unit amount as a return value and a VM count and a value e to be described below.

f(VM count,time)=VM count*f′(time)+e Formula (1)

Similarly, the above function g(VM count, time) can be converted as following Formula (2). That is, a function using a VM count and time as arguments and host disk usage status as a return value can be converted into a sum of a product of a function using time as an argument and host disk usage status in a VM per unit amount as a return value and a VM count and the value e to be described below.

g(VM count,time)=VM count*g′(time)+e Formula (2)

f′ (time) in Formula (1) is a host CPU usage rate per unit VM at certain time, and g′ (time) in Formula (2) is host disk usage status per unit VM at certain time.

Furthermore, the value e in Formulas (1) and (2) represents a work load generated under a condition other than that the host performs the VMs, for example, a CPU usage amount generated when a host operating system (OS) is performed. To improve the accuracy of algorithm, e is adjustable.

In order to obtain f′ (time) in Formula (1) and g′ (time) in Formula (2), various methods can be used. In order to perform future performance prediction, various types of information of work loads need to be predicted. In the present embodiment, on the premise that work loads do not change, for example, the usage of resources by users does not change at the same time in one day under the same condition, for example, on the same day of the week or the like, f′ (time) can be derived as a function using a CPU usage rate per unit VM as a return value by a host CPU usage rate being divided at each time by a VM count from the past log data.

Similarly, on the premise that work loads do not change under the same conditions, for example, on the same day of the week or the like as described above, g′ (time) can be derived as a function using host disk usage status per unit VM as a return value by host disk usage status being divided at each time by a VM count from the past log data.

Furthermore, the present invention is not limited to the above example, and for example, the above f′ (time) and g′ (time) may be derived as functions using a resource usage rate per unit VM at any time in the future as a return value using time series forecasting.

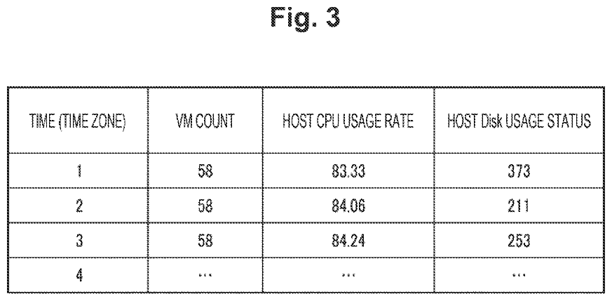

FIG. 3 is a diagram illustrating an example of a VM count, a host CPU usage rate, and host disk usage status at each time in the past log data in a table format.

In the example illustrated in FIG. 3, relationship among a count of VMs operating at each past time, a host CPU usage rate related to corresponding operating VMs, and host disk usage status related to corresponding operating VMs is illustrated.

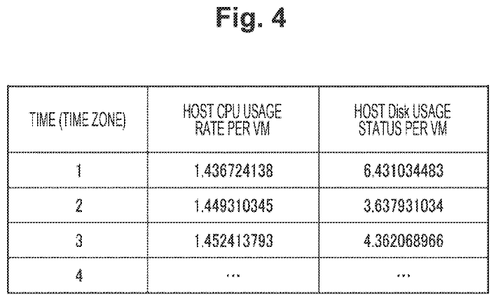

FIG. 4 is a diagram illustrating an example of a host CPU usage rate per unit VM and host disk usage status per unit VM at each time in a table format.

In the example illustrated in FIG. 4, relationship between each time and a host CPU usage rate per unit VM corresponds to the function f′ (time) indicated by above Formula (1). A host CPU usage rate per unit VM illustrated in FIG. 4 is a value obtained by dividing a host CPU usage rate illustrated in FIG. 3 by a count of VMs operating at the same time at each time on the assumption that e in above Formula (1) is 0.

Furthermore, relationship between each time and host disk usage status per unit VM corresponds to the function g′ (time) indicated by above Formula (2). In the example illustrated in FIG. 4, host disk usage status per unit VM is a value obtained by dividing host disk usage status illustrated in FIG. 3 by a count of VMs operating at the same time at each time on the assumption that e in above Formula (2) is 0.

Relationship between each time and a host CPU usage rate per unit VM illustrated in above FIG. 4 can be indicated as, for example, following Formula (3) using the host CPU usage rate per unit VM as the above f′ (time).

$$\begin{matrix}[ Math . 1 ] & \\ {f}^{′} ( time ) = \{ \begin{matrix}1.436724138 when t = 1 \\ 1.449310345 when t = 2 \\ 1.452413793 when t = 3 \\ .. when t = ..\end{matrix} & Formula ( 3 )\end{matrix}$$

Furthermore, relationship between each time and host disk usage status per unit VM illustrated in above FIG. 4 can be indicated as, for example, following Formula (4) using the host disk usage status per unit VM as the above g′ (time). In an actual program, calculation can be performed more efficiently by a vector being handled.

$$\begin{matrix}[ Math . 2 ] & \\ {g}^{′} ( time ) = \{ \begin{matrix}6.431034483 when t = 1 \\ 3.637931034 when t = 2 \\ 4.362068966 when t = 3 \\ .. when t = ..\end{matrix} & Formula ( 4 )\end{matrix}$$

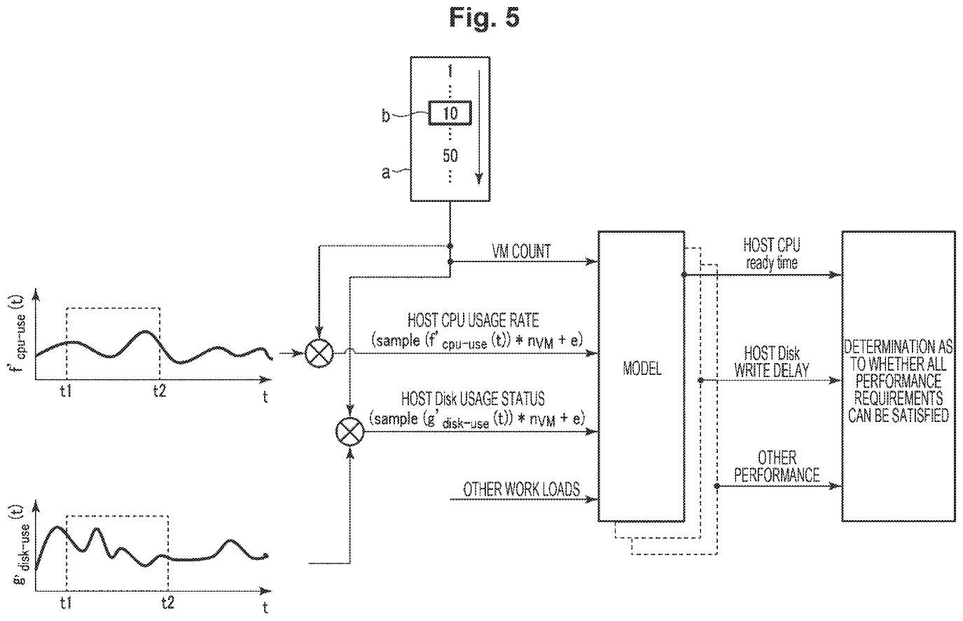

FIG. 5 is a diagram illustrating an example of input and output by the optimum VM count calculation unit of the resource determination device according to the one embodiment of the present invention.

Here, as a premise, firstly, it is assumed that the model generation unit 11 generates a model using a VM count, a host CPU usage rate, host disk usage status, and other work loads as feature variables and host CPU ready time as an objective variable.

Secondly, it is assumed that the host CPU usage rate and the host disk usage status are extracted by the highly related feature amount extraction unit 13 as types of highly related feature amounts.

Thirdly, it is assumed that the function indicated by above Formula (3) is derived for the above extracted host CPU usage rate by the VM count function derivation unit 14 according to the extraction result, and the function indicated by above Formula (4) is derived for the above extracted host disk usage status.

As illustrated in FIG. 5, a set C of n_{VM}s that are VM counts that are settable by a user, and information of any date and time are stored in the internal memory of the resource determination device 10 or a separate storage device. In the example illustrated in FIG. 5, the range of n_{VM}s that are the settable VM counts is 1 to 50 indicated by a reference sign a in FIG. 5.

Furthermore, the optimum VM count calculation unit 12 inputs, to the model, a value set by a user among the above n_{VM}, for example, “10” indicated by a reference sign b in FIG. 5 as the VM count that is one of the feature variables of the model.

The optimum VM count calculation unit 12 also inputs, to the model, a value indicated by following Formula (5) in which (1) a value set by the user among the above n_{VM} and (2) a value of e are reflected for a value obtained by sampling any date and time, here, a return value reflecting a designated time zone t1 to t2 in the function indicated by Formula (3), for example, the maximum value of a host CPU usage rate in the designated time zone t1 to t2, as the host CPU usage rate that is one of the feature variables of the model that outputs host CPU ready time as an objective variable and is a first type of the above highly related feature amounts.

$$sample ( {{f}^{′}}_{cpu - use} ( t ) ) * {n}_{VM} + e \qquad Formula ( 5 )$$

Furthermore, the optimum VM count calculation unit 12 also inputs, to the model, a value indicated by following Formula (6) in which (1) the value set by the user among the above n_{VM} and (2) the value of e are reflected for a value obtained by sampling any date and time, here, a return value reflecting the designated time zone t1 to t2 in the function indicated by Formula (4), for example, the maximum value of host disk usage status in the designated time zone t1 to t2, as the host disk usage status that is one of the feature variables of the model that outputs host CPU ready time as an objective variable and is a second type of the above highly related feature amounts.

$$sample ( {{g}^{′}}_{disk - use} ( t ) ) * {n}_{VM} + e \qquad Formula ( 6 )$$

FIG. 5 illustrates an example in which the host CPU usage rate and the host disk usage status that are highly related feature amounts are expressed as linear functions of the VM count.

As a result of inputting values of (1) the VM count, (2) the host CPU usage rate, (3) the host disk usage status, and (4) other work loads as the above feature variables to the above model, host CPU ready time is output from the model.

Furthermore, as illustrated in FIG. 5, in a case where a model that outputs host disk write delay as an objective variable or a model that outputs other performance as an objective variable is generated by the model generation unit 11 separately from the above model, similarly, (1) a VM count, (2) a host CPU usage rate, (3) host disk usage status, and (4) other work loads are input to the model, so that output corresponding to the objective variable is performed.

Hereinafter, a specific example of processing by the optimum VM count calculation unit 12 according to the input and output illustrated in above FIG. 5 will be described.

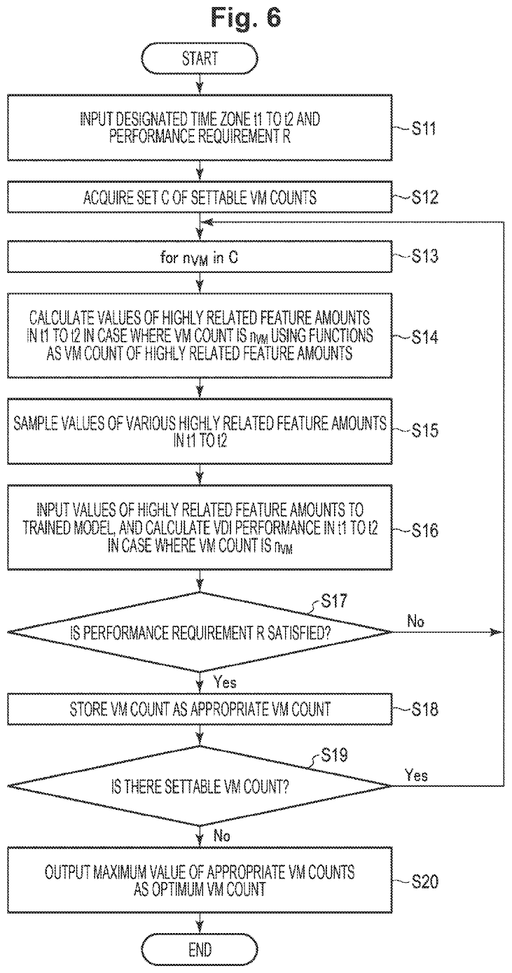

FIG. 6 is a flowchart illustrating an example of processing operation by the optimum VM count calculation unit of the resource determination device according to the one embodiment of the present invention.

First, the optimum VM count calculation unit 12 inputs any designated time zone and performance requirement R of the VDI, and outputs an optimum VM count satisfying the above VDI performance requirement R in the above designated time zone by various types of processing.

The optimum VM count calculation unit 12 inputs (1) any designated time zone t1 to t2 (=1, 2, 3, . . . ), for example, “9:00 to 12:00 on the next day (Monday)”, and (2) any performance requirement R, for example, “the host CPU ready time is 5 seconds or less” (S11).

The optimum VM count calculation unit 12 acquires a set C of VM counts that can be set (designated) by a user from the internal memory of the resource determination device 10 or the like (S12). Here, it is assumed that the set C of the VM counts is 1 to 50, that is, in a range of 1 to 50.

The optimum VM count calculation unit 12 sets a VM count designated by an input operation by the user from the set C acquired in S12 (for nm in C) (S13). Here, it is assumed that the designated VM count is 10.

The optimum VM count calculation unit 12 calculates values of various highly related feature amounts when time is each time t (=1, 2, 3, . . . ) within the range of the above designated time zone t1 to t2 in a case where the VM count is n_{VM} in Formulas (5) and (6) using the VM count set in S13 for functions derived by the VM count function derivation unit 14 that are used to obtain highly related feature amounts related to types extracted by the highly related feature amount extraction unit 13 (S14).

Specifically, regarding a host CPU usage rate that is a first highly related feature amount extracted by the highly related feature amount extraction unit 13, the optimum VM count calculation unit 12 calculates, as the host CPU usage rate, a value indicated by a result of following Formula (7) when “10” set in above S13 is substituted into n_{VM} in above Formula (5) and each time t (=1, 2, 3, . . . ) within the range of the above designated time zone t1 to t2 is substituted into t in above Formula (5). Here, it is assumed that e=0.

$$\begin{matrix}[ Math . 3 ] & \\ Host CPU usage rate = 10 * {f}^{′} ( time ) = \{ \begin{matrix}14.36724138 when t = 1 \\ 14.49310345 when t = 2 \\ 14.52413793 when t = 3 \\ .. when t = ..\end{matrix} & Formula ( 7 )\end{matrix}$$

Similarly, regarding host disk usage status that is a second highly related feature amount extracted by the highly related feature amount extraction unit 13, the optimum VM count calculation unit 12 calculates, as the host disk usage status, a value indicated by a result of following Formula (8) when “10” set in above S13 is substituted into n_{VM} in above Formula (6) and each time t (=1, 2, 3, . . . ) within the range of the above designated time zone t1 to t2 is substituted into t in above Formula (6). Here, it is assumed that e=0.

$$\begin{matrix}[ Math . 4 ] & \\ Host Disk usage status = 10 * {g}^{′} ( time ) = \{ \begin{matrix}64.31034483 when t = 1 \\ 36.37931034 when t = 2 \\ 43.62068966 when t = 3 \\ .. when t = ..\end{matrix} & Formula ( 8 )\end{matrix}$$

The optimum VM count calculation unit 12 samples values of the various highly related feature amounts in the above designated time zone t1 to t2 calculated in S14 (S15).

This sampling is processing for reducing a subsequent calculation amount, and is not essential processing. There are various methods for sampling, and examples thereof include extracting maximum values of the various highly related feature amounts in the above designated time zone t1 to t2.

Next, the optimum VM count calculation unit 12 inputs the values of the various highly related feature amounts sampled in S15 to the feature variables of the above generated model, and calculates VDI performance at each time within the range of the above designated time zone t1 to t2 when the VM count is set as described above (S16). Here, for example, host CPU ready time when time t in the above designated time zone t1 to t2 is 1 (=4.2), host CPU ready time when the time t is 2 (=5.0), and host CPU ready time when the time t is 3 (=6.1) are calculated.

The optimum VM count calculation unit 12 determines whether the performance calculated in S16 satisfies the above set performance requirement R (S16). In a case where the determination in S16 is “No”, the processing returns to S13, and another VM count is set. In a case where the determination in S16 is “Yes”, the VM count set in S13 related to the calculation is stored as an appropriate VM count in the internal memory of the resource determination device 10 or the like (S18).

In a case where the VM count is 10 as described above, since “4.2”, “5.0”, and “6.1” that are host CPU ready time when the time t is “1”, “2”, and “3”, respectively, do not satisfy the host CPU ready time (=5 seconds or less) that is the above performance requirement, the determination in S16 is “No”, and another VM count is set.

After S18, when there is another settable VM count in the above set C (Yes in S19), the processing returns to S13, and the another VM count is set.

On the other hand, when there is no other settable VM count in the set C (No in S19), the optimum VM count calculation unit 12 calculates the maximum value of appropriate VM counts stored in S18 as an optimum VM count, and outputs the optimum VM count (S20).

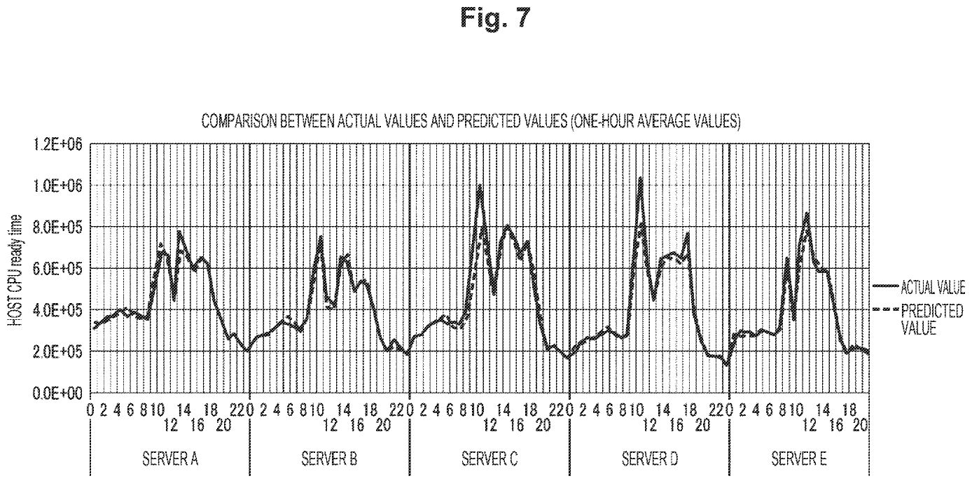

FIG. 7 is a diagram illustrating an example of a comparison result between predicted values and actual values of performance by the resource determination device according to the one embodiment of the present invention. FIG. 7 illustrates an example in which in each of five VDI servers, performance predicted values calculated by the optimum VM count calculation unit 12 and actual values of performance under the same condition are compared for one-hour average values. As illustrated in FIG. 7, errors between the performance predicted values calculated using highly related feature amounts and the actual values are small. That is, the optimum VM count calculation unit 12 can predict performance with high accuracy. Therefore, a VM count satisfying a performance requirement can be calculated with high accuracy.

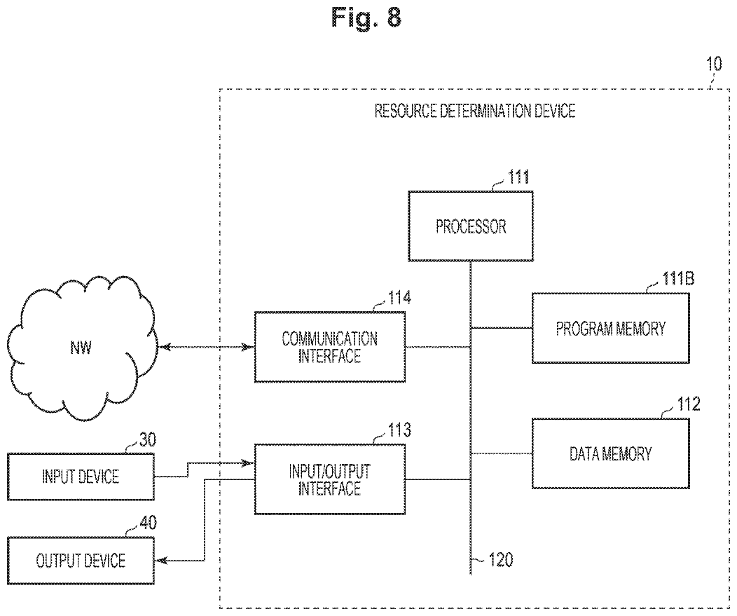

FIG. 8 is a block diagram illustrating an example of a hardware configuration of the resource determination device according to the one embodiment of the present invention.

In the example illustrated in FIG. 8, the resource determination device 10 according to the above embodiment includes, for example, a server computer or a personal computer, and includes a hardware processor 111A such as a CPU. A program memory 111B, a data memory 112, an input/output interface 113, and a communication interface 114 are connected to the hardware processor 111A via a bus 120.

The communication interface 114 includes, for example, one or more wireless communication interface units, and enables transmission and reception of information to and from a communication network NW. As the wireless interface, for example, an interface in which a low-power wireless data communication standard such as a wireless local area network (LAN) is adopted is used.

An input device 200 and an output device 300 that are attached to the resource determination device 10 and that are used by a user or the like are connected to the input/output interface 113.

The input/output interface 113 can perform processing of fetching operation data input by a user or the like through the input device 200 such as a keyboard, a touch panel, a touchpad, or a mouse, and outputting output data to the output device 300 including a display device using liquid crystal, organic electro-luminescence (EL), or the like to make the output data displayed. Note that, as the input device 200 and the output device 300, a device built in the resource determination device 10 may be used, and an input device and an output device of another information terminal that can communicate with the resource determination device 10 via the network NW may be used.

The program memory 111B is used as a non-transitory tangible storage medium, for example, in a combination of non-volatile memory enabling writing and reading at any time, such as a hard disk drive (HDD) or a solid state drive (SSD), and non-volatile memory such as read only memory (ROM), and can store programs necessary for executing various control processing according to the one embodiment.

The data memory 112 is used as a tangible storage medium, for example, in a combination of the non-volatile memory described above and volatile memory such as random access memory (RAM), and can be used to store various types of data or information acquired and created in the process of performing various types of processing. The data memory 112 can store various types of data or information including the model generated by the model generation unit 11 illustrated in FIG. 1, the optimum VM count calculated by the optimum VM count calculation unit 12, information of the highly related feature amounts extracted by the highly related feature amount extraction unit 13, and the functions derived by the VM count function derivation unit 14.

The resource determination device 10 according to the one embodiment of the present invention can be formed as a data processing device including the model generation unit 11, the optimum VM count calculation unit 12, the highly related feature amount extraction unit 13, and the VM count function derivation unit 14 illustrated in FIG. 1 as processing function units by software.

Information storage units used as work memories or the like by the respective units of the resource determination device 10 can be formed using the data memory 112 illustrated in FIG. 8. However, these formed storage areas are not essential configurations in the resource determination device 10, and may be areas provided in, for example, an external storage medium such as a universal serial bus (USB) memory or a storage device such as a database server arranged in a cloud.

All of the processing function units in the respective units of the model generation unit 11, the optimum VM count calculation unit 12, the highly related feature amount extraction unit 13, and the VM count function derivation unit 14 described above can be implemented by the above hardware processor 111A being caused to read and execute programs stored in the program memory 111B. Note that some or all of these processing function units may be implemented in other various forms including an integrated circuit such as an application specific integrated circuit (ASIC) or a field-programmable gate array (FPGA).

A resource determination device according to the one embodiment of the present invention, using a model that indicates relationship among resource arrangement of a virtual machine, a plurality of types of processing loads of the virtual machine, and processing performance of the virtual machine, extracts a type of a processing load having relatively high relevance to the processing performance from the plurality of types of processing loads, derives a function using at least the resource arrangement as an argument and a processing load related to the extracted type as a return value, and calculates the processing load in the resource arrangement that is designated on the basis of the derived function, calculates the processing performance in the designated resource arrangement by inputting the calculated processing load to the model, and determines that the designated resource arrangement is appropriate resource arrangement in a case where the calculated processing performance satisfies a requirement of corresponding processing performance, so that a resource amount to be allocated can be calculated with high accuracy.

Furthermore, the methods described in the embodiments can be stored in a recording medium such as a magnetic disk (Floppy (registered trademark) disk, hard disk, and the like), an optical disc (CD-ROM, DVD, MO, and the like), or a semiconductor memory (ROM, RAM, flash memory, and the like) as a program (software means) that can be executed by a computer, and can be distributed by being transmitted through a communication medium. Note that the programs stored on the medium side also include a setting program for configuring, in the computer, a software means (including not only an execution program but also tables and data structures) to be executed by the computer. The computer that implements the present device executes the above-described processing by reading the programs recorded in the recording medium, constructing the software means by the setting program as needed, and controlling the operation by the software means. Note that the recording medium described in the present specification is not limited to a recording medium for distribution, but includes a storage medium such as a magnetic disk or a semiconductor memory provided in the computer or in a device connected via a network.

Note that the present invention is not limited to the embodiments described above, and various modifications can be made to them in the implementation stage without departing from the scope of the invention. Furthermore, the embodiments may be implemented in appropriate combination, and in this case, combined effects can be obtained. Furthermore, the embodiments described above include various inventions, and various inventions can be extracted by a combination selected from a plurality of disclosed components. For example, even if some components are deleted from all the components described in the embodiments, in a case where the issue can be solved and the effects can be obtained, a configuration from which the components are deleted can be extracted as an invention.

### REFERENCE SIGNS LIST

10 Resource determination device
11 Model generation unit
12 Optimum VM count calculation unit
13 Highly related feature amount extraction unit
14 VM count function derivation unit

1. A resource determination device comprising:
a storage unit that stores a model that indicates relationship among resource arrangement of a virtual machine, a plurality of types of processing loads of the virtual machine, and processing performance of the virtual machine;
an extraction unit that extracts a type of a processing load having relatively high relevance to the processing performance from the plurality of types of processing loads;
a function derivation unit that derives a function using the resource arrangement as an argument and a processing load related to a type extracted by the extraction unit as a return value; and
a determination unit that
calculates the processing load in the resource arrangement that is designated on a basis of a function derived by the function derivation unit,
calculates the processing performance in the designated resource arrangement by inputting the calculated processing load to the model, and
determines that the designated resource arrangement is appropriate resource arrangement in a case where the calculated processing performance satisfies a requirement of corresponding processing performance.

2. The resource determination device according to claim 1,
wherein the function derivation unit
derives a function using the resource arrangement and time as arguments and a processing load related to a type extracted by the extraction unit as a return value, and
the determination unit
calculates the processing load in the designated resource arrangement at designated time on a basis of a function derived by the function derivation unit,
calculates the processing performance in the designated resource arrangement and at the designated time by inputting the calculated processing load to the model, and
determines that the designated resource arrangement is appropriate resource arrangement in a case where the calculated processing performance satisfies a requirement of corresponding processing performance.

3. The resource determination device according to claim 2,
wherein the function derivation unit
converts the derived function into a product of a function using time as an argument and a processing load in the resource arrangement per unit amount as a return value and the resource arrangement, and
the determination unit
calculates the processing load in the resource arrangement that is designated at the designated time on a basis of a result obtained by the conversion,
calculates the processing performance in the designated resource arrangement and at the designated time by inputting the calculated processing load to the model, and
determines that the designated resource arrangement is appropriate resource arrangement in a case where the calculated processing performance satisfies a requirement of corresponding processing performance.

4. The resource determination device according to claim 2,
wherein the determination unit
calculates the processing load in the designated resource arrangement at the designated time on a basis of a function derived by the function derivation unit,
samples the calculated processing load at the designated time,
calculates the processing performance in the designated resource arrangement and at the designated time by inputting the sampled processing load to the model, and
determines that the designated resource arrangement is appropriate resource arrangement in a case where the calculated processing performance satisfies a requirement of corresponding processing performance.

5. A resource determination method performed by a resource determination device that uses a model that indicates relationship among resource arrangement of a virtual machine, a plurality of types of processing loads of the virtual machine, and processing performance of the virtual machine, the resource determination method comprising:
extracting a type of a processing load having relatively high relevance to the processing performance from the plurality of types of processing loads;
deriving a function using the resource arrangement as an argument and a processing load related to the extracted type as a return value; and
calculating the processing load in the resource arrangement that is designated on a basis of the derived function,
calculating the processing performance in the designated resource arrangement by inputting the calculated processing load to the model, and
determining that the designated resource arrangement is appropriate resource arrangement in a case where the calculated processing performance satisfies a requirement of corresponding processing performance.

6. The resource determination method according to claim 5,
wherein the deriving a function includes
deriving a function using the resource arrangement and time as arguments and a processing load related to the extracted type as a return value, and
the determining includes
calculating the processing load in the designated resource arrangement at designated time on a basis of the derived function,
calculating the processing performance in the designated resource arrangement and at the designated time by inputting the calculated processing load to the model, and
determining that the designated resource arrangement is appropriate resource arrangement in a case where the calculated processing performance satisfies a requirement of corresponding processing performance.

7. The resource determination method according to claim 6,
wherein the deriving a function
converts the derived function into a product of a function using time as an argument and a processing load in the resource arrangement per unit amount as a return value and the resource arrangement, and
the determining includes
calculating the processing load in the resource arrangement that is designated at the designated time on a basis of a result obtained by the conversion,
calculating the processing performance in the designated resource arrangement and at the designated time by inputting the calculated processing load to the model, and
determining that the designated resource arrangement is appropriate resource arrangement in a case where the calculated processing performance satisfies a requirement of corresponding processing performance.

8. A resource determination processing program causing a processor to function as each unit of the resource determination device according to any one of claims 1 to 4.
